(19) United States
(12) Patent Application Publication
(10) Pub. No.: US 2024/0339930 A1
(43) Pub. Date: Oct. 10, 2024

(54) ONBOARD CONTROL APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kiyoshi AIZAWA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/700,058

(22) PCT Filed: Oct. 13, 2021
(86) PCT No.: PCT/JP2021/037806

§ 371 Date: Apr. 10, 2024

(51) Int. Cl. H02M 3/158; H02M 1/00; H02M 1/32

(52) U.S. Cl. CPC H02M 3/158; H02M 1/0009; H02M 1/327

(57) ABSTRACT

An onboard control apparatus includes a duty ratio control unit, a current control unit, and a switching unit. The duty ratio control unit performs duty ratio control so as to turn a switch on and off at a set duty ratio. The current control unit performs current control so as to change the current to be supplied to the resistor portion while continuously supplying the current to the resistor portion. The switching unit switches, when a switching condition is established while the duty ratio control unit is performing the duty ratio control, to the current control by the current control unit.

### CROSS-REFERENCE TO RELATED APPLICATIONS

This application is the U.S. national stage of PCT/JP2021/037806 filed on Oct. 13, 2021, the contents of which are incorporated herein.

### TECHNICAL FIELD

The present disclosure relates to an onboard control apparatus.

### BACKGROUND

JP 2012-215145A discloses a catalyst power supply control apparatus that activates a catalyst with heat generated by supplying power to a catalyst device (e.g., EHC (Electrically Heated Catalyst)). The control apparatus causes power to be supplied to a base material that supports the catalyst while performing duty ratio control on power to be supplied to the base material.

In JP 2012-215145A, the base material has a characteristic in which the electric resistance thereof decreases as the temperature increases. Therefore, the current flowing through the base material increases, as the temperature of the base material increases. Although the control apparatus performs duty ratio control, an increase in the current flowing in a power-on period to a large current is unavoidable. There is concern that, as the current flowing through the base material increases, the change in current during duty ratio control will increase, and radiation noise will increase.

The present disclosure provides a technique for suppressing radiation noise that is generated when a heating object is heated from becoming too large.

### SUMMARY

An onboard control apparatus of the present disclosure is an onboard control apparatus that is used in an onboard system including a power supply unit, a heating object including a resistor portion whose resistance decreases as the temperature increases, a power path for supplying power based on the power supply unit to the resistor portion, and a switch provided on the power path, and that controls power supply to the heating object, the onboard control apparatus including: a duty ratio control unit configured to perform duty ratio control so as to turn the switch on and off at a set duty ratio; a current control unit configured to perform current control so as to change a current to be supplied to the resistor portion while causing the current to be continuously supplied to the resistor portion; and a switching unit configured to switch, when a switching condition is established while the duty ratio control unit is performing the duty ratio control, to the current control by the current control unit.

### Advantageous Effects

According to the present disclosure, radiation noise that is generated when a heating object is heated can be suppressed from becoming too large.

### BRIEF DESCRIPTION OF DRAWINGS

FIG. 1 is a configuration diagram schematically illustrating an onboard system of a first embodiment.

FIG. 2A is a graph illustrating a change in resistance of a resistor portion over time.

FIG. 2B is a graph illustrating a change in current flowing through the resistor portion over time.

FIG. 3 is a configuration diagram schematically illustrating an onboard system of a second embodiment.

FIG. 4 is a configuration diagram schematically illustrating an onboard system of a third embodiment.

FIG. 5 is a configuration diagram schematically illustrating an onboard system of a fourth embodiment.

FIG. 6 is a configuration diagram schematically illustrating an onboard system of a sixth embodiment.

FIG. 7 is a configuration diagram schematically illustrating an onboard system of a seventh embodiment.

### DETAILED DESCRIPTION OF PREFERRED EMBODIMENTS

Embodiments of the present disclosure will be enumerated and illustrated below.

An onboard control apparatus of the present disclosure is an onboard control apparatus that is used in an onboard system including a power supply unit, a heating object including a resistor portion whose resistance decreases as the temperature increases, a power path for supplying power based on the power supply unit to the resistor portion, and a switch provided on the power path, and controls power supply to the heating object, the onboard control apparatus including: a duty ratio control unit configured to perform duty ratio control so as to turn the switch on and off at a set duty ratio; a current control unit configured to perform current control so as to change a current to be supplied to the resistor portion while continuously supplying the current to the resistor portion; and a switching unit configured to switch, when a switching condition is established while the duty ratio control unit is performing the duty ratio control, to the current control by the current control unit.

When supplying power to the resistor portion, the onboard control apparatus performs the duty ratio control in an initial phase in which the resistance of the resistor portion is high, and can smoothly increase the temperature of the resistor portion. Moreover, when the switching condition is established, the onboard control apparatus can switch to the current control so as to change the current to be supplied to the resistor portion while continuously supplying the current. In the current control, the change in current is kept small, and therefore generation of radiation noise can also be suppressed. That is, the onboard control apparatus can suppress the radiation noise generated when the heating object is heated from becoming too large.

The duty ratio control unit may perform the duty ratio control such that the power to be supplied to the resistor portion approaches a target power or the temperature of the heating object approaches a target temperature. The current control unit may perform, when the switching condition is established, the current control such that the power to be supplied to the resistor portion approaches the target power or the temperature of the heating object approaches the target temperature.

In the duty ratio control and the current control, the onboard control apparatus can cause the power that is supplied to the resistor portion to approach the target power, or cause the temperature of the heating object to approach the target temperature.

The switch may include an input portion, and may be turned on when a voltage greater than or equal to a threshold voltage is applied to the input portion, and turned off when a voltage less than the threshold voltage is applied to the input portion or a voltage is not applied to the input portion. The current control unit may change, in the current control, the current to be supplied to the resistor portion by adjusting the voltage applied to the input portion.

In the current control, the onboard control apparatus can change the current to be supplied to the resistor portion by adjusting the voltage applied to the input portion. That is, the onboard control apparatus can perform the current control using the switch used in the duty ratio control, and therefore the configuration can be simplified.

The onboard system may include: a parallel conduction path provided in parallel to the switch between the power supply unit and the resistor portion; and a DC-DC converter provided on the parallel conduction path. The current control unit may change, in the current control, the current to be supplied to the resistor portion by controlling the DC-DC converter while continuously supplying the current to the resistor portion.

The onboard control apparatus is provided with a DC-DC converter separately from the switch, and can perform the current control by controlling the DC-DC converter. Therefore, the onboard control apparatus can easily adjust the current to be supplied to the resistor portion.

The onboard system may include: a parallel conduction path provided in parallel to the switch between the power supply unit and the resistor portion; a suppressing circuit that is provided on the parallel conduction path and whose resistance increases as the temperature increases; and a second switch that is provided on the parallel conduction path and is connected in series to the suppressing circuit. The current control unit may turn on the second switch in the current control.

The onboard control apparatus can perform the current control by merely turning on the second switch. Therefore, the onboard control apparatus can suppress the current control from becoming complicated. Moreover, the suppressing circuit has a characteristic in which the resistance increases as the temperature increases, and therefore the characteristic of the resistor portion in which the resistance decreases as the temperature increases can be canceled out, and the current can be suppressed from increasing due to the increase in the temperature of the heating object.

The onboard system may include: a parallel conduction path provided in parallel to the switch between the power supply unit and the resistor portion; and a third switch provided on the parallel conduction path. The third switch may include a third input portion, and may be turned on when a voltage greater than or equal to a third threshold voltage is applied to the third input portion, and turned off when a voltage less than the third threshold voltage is applied to the third input portion or a voltage is not applied to the third input portion. The current control unit may change, in the current control, the current to be supplied to the resistor portion by adjusting the voltage applied to the third input portion.

The onboard control apparatus changes the current to be supplied to the resistor portion by adjusting the voltage applied to the third input portion of the third switch provided in parallel to the switch. Therefore, in the onboard control apparatus, the switch can be configured to be suitable for the duty ratio control, and the third switch can be configured to be suitable for current control.

The onboard system may include a current detecting unit configured to detect a current flowing through the resistor portion. The switching condition may be that the current detected by the current detecting unit has exceeded a threshold current.

The onboard control apparatus can aim to smoothly increase the temperature of the heating object by the duty ratio control until the current flowing through the resistor portion exceeds a threshold current, and suppress the radiation noise from becoming too large after the current flowing through the resistor portion has exceeded the threshold current.

The onboard system may include a temperature detecting unit configured to detect a temperature of the heating object. The switching condition may be that the temperature detected by the temperature detecting unit has exceeded a threshold temperature.

The onboard control apparatus can aim to smoothly increase the temperature of the heating object by the duty ratio control until the temperature of the heating object exceeds a threshold temperature, and suppress the radiation noise from becoming too large after the temperature of the heating object has exceeded the threshold temperature.

The onboard system may include a current detecting unit configured to detect a current flowing through the resistor portion, and a voltage detecting unit configured to detect a potential difference across the resistor portion. A temperature estimating unit may be included that is configured to estimate the temperature of the resistor portion based on the current detected by the current detecting unit, the voltage detected by the voltage detecting unit, and relational data indicating the relationship between the resistance and the temperature of the resistor portion. The switching condition may be that the temperature estimated by the temperature estimating unit has exceeded a threshold temperature.

The onboard control apparatus can aim to smoothly increase the temperature of the heating object by the duty ratio control until the estimated temperature of the heating object exceeds a threshold temperature, and suppress the radiation noise from becoming too large after the estimated temperature of the heating object has exceeded the threshold temperature.

The onboard system may include a second temperature detecting unit configured to detect a temperature of the switch. The switching condition may be that the temperature detected by the second temperature detecting unit has exceeded a second threshold temperature. The current control unit may perform the current control so as to supply a current smaller than a largest current in the duty ratio control to the resistor portion.

The onboard control apparatus can reduce the current to be supplied to the resistor portion when the temperature of the switch has exceeded the second threshold temperature. Therefore, the onboard control apparatus can suppress failure of the switch due to heat generation.

### First Embodiment

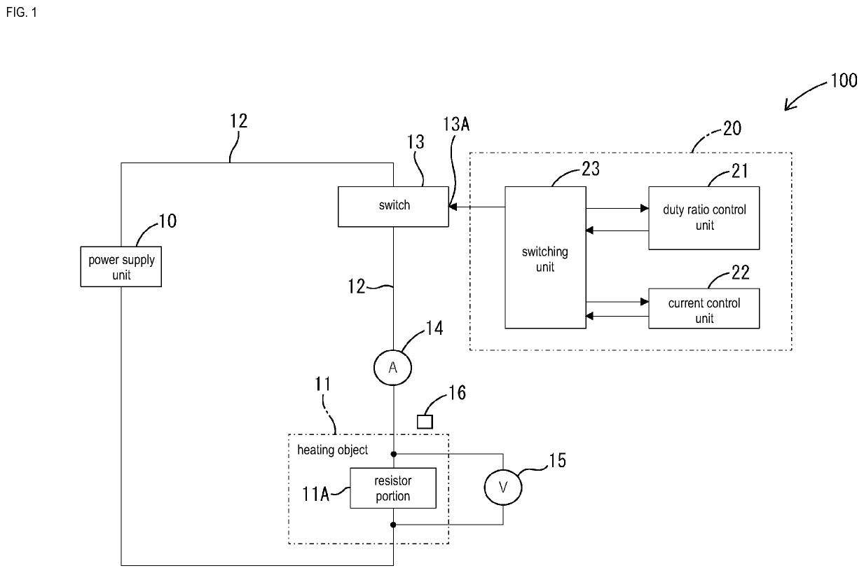

An onboard system 100 shown in FIG. 1 includes a power supply unit 10, a heating object 11, a power path 12, a switch 13, a current detecting unit 14, a voltage detecting unit 15, a temperature detecting unit 16, and an onboard control apparatus 20.

The power supply unit 10 is configured as a battery such as a lithium-ion battery, for example.

The heating object 11 is an electrically heated catalyst (EHC), for example. The heating object 11 is disposed, for example, in an exhaust pipe of an internal combustion engine, and cleans the exhaust gas by oxidizing hydrocarbon and reduces CO and NOx in the exhaust gas. The heating object 11 includes a resistor portion 11A, and a catalyst, which is not illustrated. The resistor portion 11A is configured as abase material that supports the catalyst. The resistor portion 11A is constituted by a member having conductivity, and has a characteristic in which the resistance decreases as the temperature increases. The resistor portion 11A generates heat when power is supplied. The heat generated in the resistor portion 11A is transmitted to the catalyst. Accordingly, the catalyst is heated. When the catalyst is heated, the catalyst is activated.

The power path 12 is a path for supplying power based on the power supply unit 10 to the resistor portion 11A.

The switch 13 is provided on the power path 12. The switch 13 is a semiconductor switching element, for example, such as an N-channel FET (Field Effect Transistor), for example. The switch 13 includes an input portion 13A. The input portion 13A is a gate. When a voltage greater than or equal to a threshold voltage is being applied to the input portion 13A, the switch 13 is on, and when a voltage less than the threshold voltage is being applied to the input portion 13A, or when a voltage is not being applied to the input portion 13A, the switch 13 is off. When the switch 13 is on, a current is supplied to the resistor portion 11A via the switch 13. When the switch 13 is off, the current supply to the resistor portion 11A via the switch 13 stops.

The current detecting unit 14 detects the current flowing through the resistor portion 11A. The current detecting unit 14 is configured as a known current detection circuit, for example. The current detecting unit 14 is configured as a current detection circuit using a current transformer or a shunt resistor, for example. The current detecting unit 14 detects a current flowing through the resistor portion 11A by detecting a current flowing through the power path 12.

The voltage detecting unit 15 detects a potential difference across the resistor portion 11A. The voltage detecting unit 15 is configured as a known voltage detection circuit.

The temperature detecting unit 16 detects a temperature of the heating object 11. The temperature detecting unit 16 is configured as a known temperature sensor, for example.

The onboard control apparatus 20 is an apparatus that is used in the onboard system 100. The onboard control apparatus 20 includes an MCU (Micro Controller Unit), an AD converter, a DA converter, a driving circuit, and a multiplexer, which are not illustrated. The onboard control apparatus 20 specifies the current flowing through the resistor portion 11A based on a detection value of the current detecting unit 14. The onboard control apparatus 20 specifies the potential difference across the resistor portion 11A based on a detection value of the voltage detecting unit 15. The onboard control apparatus 20 specifies the temperature of the heating object 11 based on a detection value of the temperature detecting unit 16. The onboard control apparatus 20 includes a duty ratio control unit 21, a current control unit 22, and a switching unit 23.

The duty ratio control unit 21 performs duty ratio control so as to turn the switch 13 on and off at a set duty ratio. The duty ratio control is PWM (Pulse Width Modulation) control, for example. The duty ratio refers to a ratio of the on period in one cycle. The setting of the duty ratio can be changed. The duty ratio control unit 21 is constituted by an MCU and a driving circuit.

The current control unit 22 performs current control so as to change the current supplied to the resistor portion 11A while continuously supplying the current to the resistor portion 11A. In the current control, the current to be supplied to the resistor portion 11A is smaller than a largest current that flows through the resistor portion 11A in the duty ratio control. The current control unit 22 is constituted by an MCU and a DA converter, for example.

The switching unit 23 switches, when a switching condition is established while the duty ratio control unit 21 is performing the duty ratio control, to current control by the current control unit 22. The switching condition is that the current detected by the current detecting unit 14 exceeds a threshold current, for example. The switching unit 23 is constituted by an MCU and a multiplexer, for example.

The following description relates to the details of the duty ratio control unit 21, current control unit 22, and switching unit 23.

When a start condition is established, the switching unit 23 causes the duty ratio control unit 21 to start duty ratio control. The start condition is that a starting switch (e.g., ignition switch) of a vehicle on which the onboard system 100 is mounted is switched on, for example. The switching unit 23 is configured to receive an on-off signal indicating whether a vehicle starting switch is on or off from an external ECU, for example, and determines that the starting switch has been switched on based on the on-off signal.

The duty ratio control unit 21 starts duty ratio control when the aforementioned start condition is established. The duty ratio control unit 21 performs the duty ratio control such that the power to be supplied to the resistor portion 11A approaches a target power. The duty ratio control unit 21 performs, in the duty ratio control, first duty ratio control and second duty ratio control. The first duty ratio control is control in which the duty ratio is fixed to 100%. The second duty ratio control is control in which the setting of duty ratio is changed such that the power to be supplied to the resistor portion 11A approaches a predetermined target power. The duty ratio control unit 21 calculates the power to be supplied to the resistor portion 11A per unit time based on a detection value of the current detecting unit 14 and a detection value of the voltage detecting unit 15. The duty ratio control unit 21 performs the second duty ratio control such that the power to be supplied to the resistor portion 11A approaches the target power based on the difference between the calculated power to be supplied per unit time and the target power.

The duty ratio control unit 21 starts the first duty ratio control when the aforementioned start condition is established, and switches to the second duty ratio control when a duty ratio switching condition is established. The duty ratio switching condition is that the temperature of the resistor portion 11A reaches a duty ratio switching temperature, for example.

In the duty ratio control, the duty ratio control unit 21 generates a signal with a set duty ratio (e.g., PWM signal), and outputs the signal as a first signal. The first signal is input to the switching unit 23. In a period from when the start condition is established until when the switching condition is established, that is, in a stage before the switching condition is established, the switching unit 23 selects the first signal input from the duty ratio control unit 21, and outputs the first signal to the input portion 13A of the switch 13. Accordingly, the switch 13 is subjected to duty ratio control performed by the duty ratio control unit 21, and a rectangular wave current is supplied to the resistor portion 11A.

When the aforementioned switching condition is established while the duty ratio control unit 21 is performing the duty ratio control, the switching unit 23 causes the duty ratio control unit 21 to stop the duty ratio control, and causes the current control unit 22 to perform the current control.

When the aforementioned switching condition is established, the current control unit 22 starts the current control. In the current control, the current control unit 22 changes the current to be supplied to the resistor portion 11A by adjusting the voltage applied to the input portion 13A. The current control unit 22 adjusts the voltage applied to the input portion 13A in a voltage range that is greater than or equal to the threshold voltage. For example, the current control unit 22 adjusts the voltage applied to the input portion 13A in a voltage range that is greater than or equal to the threshold voltage and less than or equal to the voltage of an on signal input to the input portion 13A of the switch 13 from the duty ratio control unit 21. Note that the voltage of the on signal input to the input portion 13A of the switch 13 from the duty ratio control unit 21 is larger than the threshold voltage. The current control unit 22 performs the current control such that the power supplied to the resistor portion 11A approaches the target power. The current control unit 22 calculates the power supplied to the resistor portion 11A per unit time based on a detection value of the current detecting unit 14 and a detection value of the voltage detecting unit 15. The current control unit 22 calculates an operation amount for causing the power to be supplied to the resistor portion 11A to approach the target power based on the difference between the calculated power supplied per unit time and the target power. Also, the current control unit 22 generates an analog voltage signal having a voltage according to the calculated operation amount, and outputs the analog voltage signal as a second signal. The second signal is input to the switching unit 23.

After the switching condition is established, the switching unit 23 selects the second signal input from the current control unit 22, and outputs the second signal to the input portion 13A of the switch 13. Accordingly, a current according to the voltage of the second signal is supplied to the resistor portion 11A.

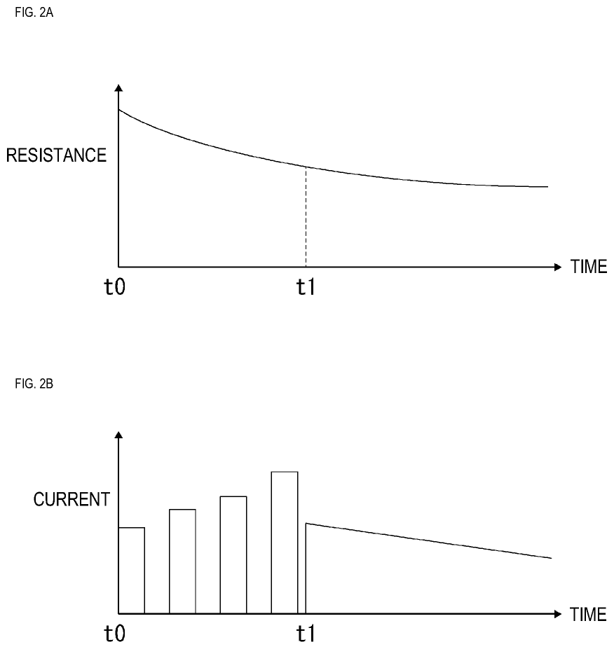

The duty ratio control unit 21 starts the duty ratio control at a timing t0 shown in FIGS. 2A and 2B. When the duty ratio control is started, power is supplied to the resistor portion 11A, and the temperature of the heating object 11 gradually increases. As the temperature of the heating object 11 increases, the resistance of the resistor portion 11A gradually decreases. Therefore, in a state in which the power to be supplied to the resistor portion 11A increases over time, or in a state in which fixed power is supplied to the resistor portion 11A, the largest current flowing through the resistor portion 11A gradually increases as the resistance of the resistor portion 11A decreases.

Upon determining that the switching condition is established at a timing t1 shown in FIGS. 2A and 2B, the switching unit 23 switches to the current control by the current control unit 22. The current control unit 22 performs, after the timing t1, the current control so as to change the current to be supplied to the resistor portion 11A while continuously supplying the current to the resistor portion 11A. Accordingly, the radiation noise is suppressed from becoming too large. Also, the current control unit 22 reduces the current to be supplied to the resistor portion 11A in the current control below the largest current to be supplied to the resistor portion 11A in the duty ratio control. Accordingly, the surge current generated when the switch 13 is switched off can be suppressed from becoming too large. Also, in the current control, as the temperature of the heating object 11 increases, the current to be supplied to the resistor portion 11A gradually decreases.

As described above, when power is supplied to the resistor portion 11A, the onboard control apparatus 20 can smoothly increase the temperature of the resistor portion 11A by performing the duty ratio control in an initial phase in which the resistance of the resistor portion 11A is high. Moreover, when the switching condition is established, the onboard control apparatus 20 can switch to the current control so as to change the current to be supplied to the resistor portion 11A while continuously supplying the current to the resistor portion 11A. In the current control, the change in current can be kept small, and therefore generation of radiation noise can be suppressed. That is, the onboard control apparatus 20 may suppress the radiation noise generated when the heating object 11 is heated from becoming too large.

Moreover, the onboard control apparatus 20 can cause the power to be supplied to the resistor portion 11A to approach the target power, in the duty ratio control and current control.

Moreover, in the current control, the onboard control apparatus 20 can change the current to be supplied to the resistor portion 11A by adjusting the voltage applied to the input portion 13A. That is, the onboard control apparatus 20 can perform the current control using the switch 13 that is used in duty ratio control, and therefore the configuration can be simplified.

Moreover, the onboard control apparatus 20 may aim to smoothly increase the temperature of the heating object 11 by the duty ratio control until the current flowing through the resistor portion 11A exceeds a threshold current, and suppress the radiation noise from becoming too large after the current flowing through the resistor portion 11A has exceeded the threshold current.

### Second Embodiment

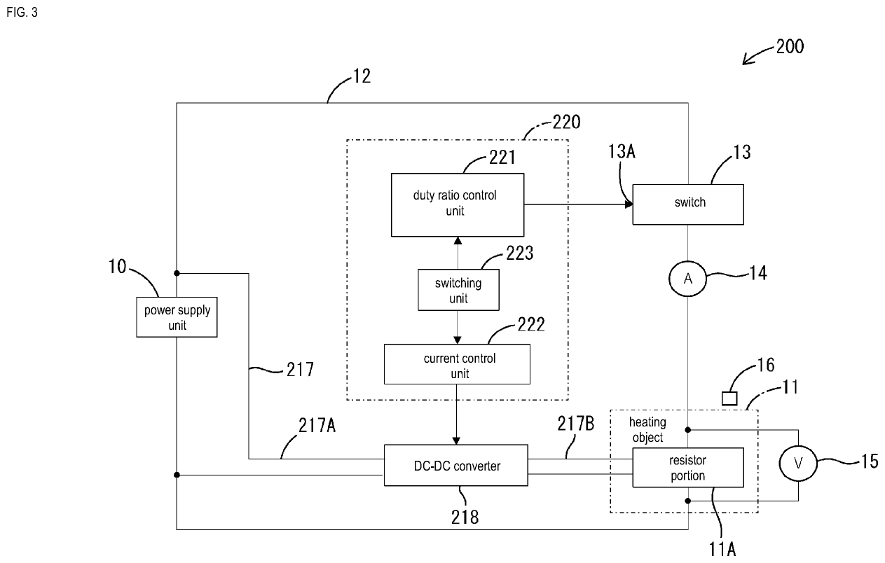

A onboard control apparatus 220 of a second embodiment shown in FIG. 3 differs from the onboard control apparatus 20 of the first embodiment in that the current control is performed using a DC-DC converter 218, and is the same in other respects. In the description of the second embodiment below, constituent elements that are the same as those of the first embodiment are given the same reference numerals, and a detailed description thereof will be omitted.

The onboard system 200 shown in FIG. 3 includes the power supply unit 10, the heating object 11, the power path 12, the switch 13, the current detecting unit 14, the voltage detecting unit 15, the temperature detecting unit 16, a parallel conduction path 217, the DC-DC converter 218, and the onboard control apparatus 220.

The parallel conduction path 217 is a path for supplying power based on the power supply unit 10 to the resistor portion 11A, and is also a path provided in parallel to the switch 13 between the power supply unit 10 and the resistor portion 11A.

The DC-DC converter 218 is provided on the parallel conduction path 217. The DC-DC converter is a step-down DC-DC converter, and performs a step-down operation in which the voltage applied to a first conduction path 217A on the power supply unit 10 is stepped down, and the stepped-down voltage is applied to a second conduction path 217B on the resistor portion 11A side.

The onboard control apparatus 220 is an apparatus to be used in the onboard system 200. The onboard control apparatus 220 includes an MCU (Micro Controller Unit), an AD converter, and a driving circuit, which are not illustrated. The onboard control apparatus 220 specifies the current flowing through the resistor portion 11A based on a detection value of the current detecting unit 14. The onboard control apparatus 220 specifies the potential difference across the resistor portion 11A based on a detection value of the voltage detecting unit 15. The onboard control apparatus 220 specifies the temperature of the heating object 11 based on a detection value of the temperature detecting unit 16. The onboard control apparatus 220 includes a duty ratio control unit 221, a current control unit 222, and a switching unit 223.

The duty ratio control unit 221 is configured similarly to the duty ratio control unit 21 of the first embodiment.

The current control unit 222 performs the current control so as to change the current to be supplied to the resistor portion 11A while continuously supplying the current to the resistor portion 11A. In the current control, the current to be supplied to the resistor portion 11A is smaller than a largest current that flows through the resistor portion 11A in the duty ratio control. The current control unit 222 is constituted by an MCU and a driving circuit, for example. The current control unit 222 performs the current control by controlling the DC-DC converter 218.

The switching unit 223 switches, when a switching condition is established while the duty ratio control unit 221 is performing the duty ratio control, to the current control by the current control unit 222. The switching condition is that the current detected by the current detecting unit 14 exceeds a threshold current, for example. The switching unit 223 is constituted by an MCU, for example.

The following description relates to the details of the duty ratio control unit 221, current control unit 222, and switching unit 223.

The switching unit 223 causes the duty ratio control unit 221 to start the duty ratio control when the start condition described in the first embodiment is established.

The duty ratio control unit 221 performs the duty ratio control similarly to the duty ratio control unit 21 of the first embodiment when the aforementioned start condition is established. A first signal output from the duty ratio control unit 221 is directly input to the input portion 13A of the switch 13 rather than via the switching unit 223. Accordingly, the switch 13 is subjected to the duty ratio control performed by the duty ratio control unit 221, and a rectangular wave current is supplied to the resistor portion 11A.

When the aforementioned switching condition is established while the duty ratio control unit 221 is performing the duty ratio control, the switching unit 223 causes the duty ratio control unit 221 to stop the duty ratio control, and causes the current control unit 222 to perform the current control.

Upon receiving a stop instruction from the switching unit 223 as a result of the aforementioned switching condition being established, the duty ratio control unit 221 outputs an off signal to the input portion 13A of the switch 13. When the off signal is input to the input portion 13A, the switch 13 is turned off, and power supply to the resistor portion 11A via the switch 13 stops.

When the aforementioned switching condition is established, the current control unit 222 starts the current control. In the current control, the current control unit 222 reduces the current to be supplied to the resistor portion 11A by causing the DC-DC converter 218 to perform a step-down operation. The current control unit 222 performs the current control such that the power supplied to the resistor portion 11A approaches the target power. The current control unit 222 calculates the power to be supplied to the resistor portion 11A per unit time based on a detection value of the current detecting unit 14 and a detection value of the voltage detecting unit 15. The current control unit 222 causes the DC-DC converter 218 to perform the step-down operation such that the power to be supplied to the resistor portion 11A approaches the target power based on the difference between the calculated power supplied per unit time and the target power.

As described above, the DC-DC converter 218 is provided separately from the switch 13, and the onboard control apparatus 220 of the second embodiment can perform the current control by controlling the DC-DC converter 218. Therefore, the onboard control apparatus 220 of the second embodiment can easily adjust the current flowing through the resistor portion 11A.

### Third Embodiment

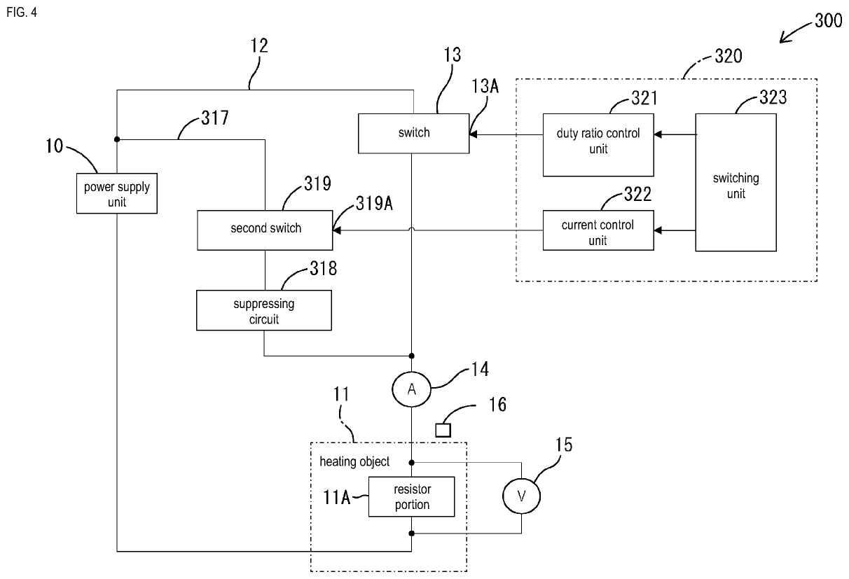

A onboard control apparatus 320 of a third embodiment shown in FIG. 4 differs from the onboard control apparatus 20 of the first embodiment in that the current control is performed using a suppressing circuit 318 provided on a parallel conduction path 317, and is the same in other respects. In the description of the third embodiment below, constituent elements that are the same as those of the first embodiment are given the same reference numerals, and a detailed description thereof will be omitted.

An onboard system 300 shown in FIG. 4 includes the power supply unit 10, the heating object 11, the power path 12, the switch 13, the current detecting unit 14, the voltage detecting unit 15, the temperature detecting unit 16, the parallel conduction path 317, the suppressing circuit 318, a second switch 319, and the onboard control apparatus 320.

The parallel conduction path 317 is a path for supplying power based on the power supply unit 10 to the resistor portion 11A, and is also a path provided in parallel to the switch 13 between the power supply unit 10 and the resistor portion 11A.

The suppressing circuit 318 is provided on the parallel conduction path 317. The suppressing circuit 318 has a characteristic in which the resistance increases as the temperature increases. The suppressing circuit 318 is a PTC (Positive Temperature Coefficient) element or resistor, for example.

The second switch 319 is provided in series to the suppressing circuit 318, on the parallel conduction path 317. The second switch 319 is a semiconductor switching element, for example, such as an N-channel FET (Field Effect Transistor), for example. The second switch 319 includes a second input portion 319A. The second input portion 319A is a gate. When a voltage greater than or equal to a second threshold voltage is applied to the second input portion 319A, the second switch 319 is turned on, and when a voltage less than the second threshold voltage is applied or when a voltage is not applied to the second input portion 319A, the second switch 319 is turned off. When the second switch 319 is on, a current is supplied to the resistor portion 11A via the second switch 319. When the second switch 319 is off, the current supply to the resistor portion 11A via the second switch 319 stops.

The onboard control apparatus 320 is an apparatus to be used in the onboard system 300. The onboard control apparatus 320 includes an MCU (Micro Controller Unit), an AD converter, and a driving circuit, which are not illustrated. The onboard control apparatus 320 specifies the current flowing through the resistor portion 11A based on a detection value of the current detecting unit 14. The onboard control apparatus 320 specifies the potential difference across the resistor portion 11A based on a detection value of the voltage detecting unit 15. The onboard control apparatus 320 specifies the temperature of the heating object 11 based on a detection value of the temperature detecting unit 16. The onboard control apparatus 320 includes a duty ratio control unit 321, a current control unit 322, and a switching unit 323.

The duty ratio control unit 321 is configured similarly to the duty ratio control unit 21 of the first embodiment.

The current control unit 322 performs the current control so as to change the current supplied to the resistor portion 11A while continuously supplying the current to the resistor portion 11A. In the current control, the current to be supplied to the resistor portion 11A is smaller than a largest current that flows through the resistor portion 11A in the duty ratio control. The current control unit 322 is constituted by an MCU and a driving circuit, for example. In the current control, the current control unit 322 applies an on signal to the second input portion 319A of the second switch 319.

The switching unit 323 switches, when a switching condition is established while the duty ratio control unit 321 is performing the duty ratio control, to the current control by the current control unit 322. The switching condition is that the current detected by the current detecting unit 14 exceeds a threshold current, for example. The switching unit 323 is constituted by an MCU, for example.

The following description relates to the details of the duty ratio control unit 321, current control unit 322, and switching unit 323.

The switching unit 323 causes the duty ratio control unit 321 to start the duty ratio control when the start condition described in the first embodiment is established. Note that, here, the current control by the current control unit 322 is not performed. That is, the second switch 319 is kept in an off state.

The duty ratio control unit 321 performs the duty ratio control similarly to the duty ratio control unit 21 of the first embodiment when the aforementioned start condition is established. A first signal output from the duty ratio control unit 321 is directly input to the input portion 13A of the switch 13 rather than via the switching unit 323. Accordingly, the switch 13 is subjected to the duty ratio control performed by the duty ratio control unit 321, and a rectangular wave current is supplied to the resistor portion 11A.

When the aforementioned switching condition is established while the duty ratio control unit 321 is performing the duty ratio control, the switching unit 323 causes the duty ratio control unit 321 to stop the duty ratio control, and causes the current control unit 322 to perform the current control.

Upon receiving a stop instruction from the switching unit 323 as a result of the aforementioned switching condition being established, the duty ratio control unit 321 outputs an off signal to the input portion 13A of the switch 13. When the off signal is input to the input portion 13A, the switch 13 is turned off, and power supply to the resistor portion 11A via the switch 13 stops.

When the aforementioned switching condition is established, the current control unit 322 starts the current control. In the current control, the current control unit 322 applies the on signal to the second input portion 319A of the second switch 319, and switches on the second switch 319. Accordingly, a current whose amount has been reduced by the suppressing circuit 318 is supplied to the resistor portion 11A.

As described above, the onboard control apparatus 320 of the third embodiment can perform the current control by merely turning on the second switch 319. Therefore, with the onboard control apparatus 320, the complexity of the configuration for performing the current control can be suppressed from increasing. Moreover, the suppressing circuit 318 has a characteristic in which the resistance increases as the temperature increases. Therefore, the characteristic of the resistor portion 11A in which the resistance decreases as the temperature increases is canceled out, and as a result, an increase in current due to the temperature increase of the heating object 11 can be suppressed.

### Fourth Embodiment

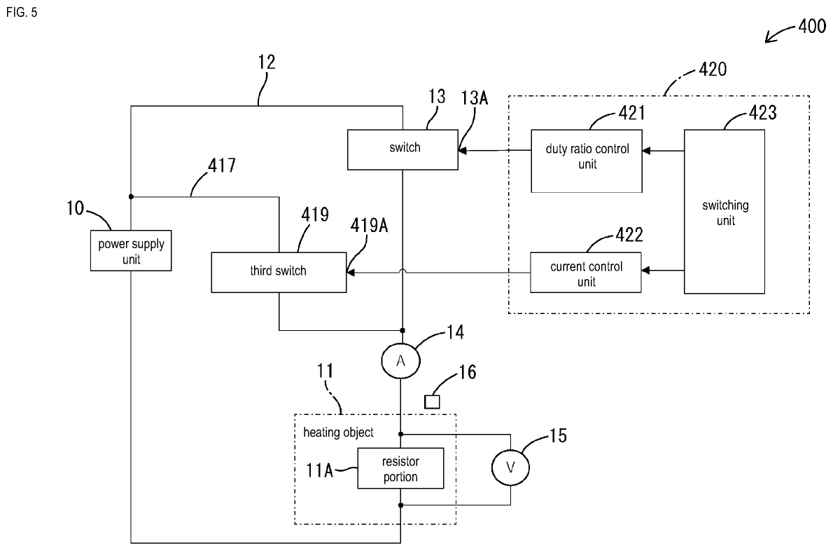

A onboard control apparatus 420 of a fourth embodiment shown in FIG. 5 differs from the onboard control apparatus 20 of the first embodiment in that the current control is performed using a third switch 419 provided on a parallel conduction path 417, and is the same in other respects. In the description of the fourth embodiment below, constituent elements that are the same as those of the first embodiment are given the same reference numerals, and a detailed description thereof will be omitted.

An onboard system 400 shown in FIG. 5 includes the power supply unit 10, the heating object 11, the power path 12, the switch 13, the current detecting unit 14, the voltage detecting unit 15, the temperature detecting unit 16, the parallel conduction path 417, the third switch 419, and the onboard control apparatus 420.

The parallel conduction path 417 is a path for supplying power based on the power supply unit 10 to the resistor portion 11A, and is also a path provided in parallel to the switch 13 between the power supply unit 10 and the resistor portion 11A.

The third switch 419 is provided on the parallel conduction path 417. The third switch 419 is a semiconductor switching element, for example, such as an N-channel FET (Field Effect Transistor), for example. The third switch 419 includes a third input portion 419A. The third input portion 419A is a gate. When a voltage greater than or equal to a third threshold voltage is applied to the third input portion 419A, the third switch 419 is turned on, when a voltage less than the third threshold voltage is applied or when a voltage is not applied to the third input portion 419A, the third switch 419 is turned off. When the third switch 419 is on, a current is supplied to the resistor portion 11A via the third switch 419. When the third switch 419 is off, the current supply to the resistor portion 11A via the third switch 419 stops. Note that, in the present embodiment, the third threshold voltage is the same as the threshold voltage, but may also be different from the threshold voltage.

The onboard control apparatus 420 is an apparatus to be used in the onboard system 400. The onboard control apparatus 420 includes an MCU (Micro Controller Unit), an AD converter, a DA converter, and a driving circuit, which are not illustrated. The onboard control apparatus 420 specifies the current flowing through the resistor portion 11A based on a detection value of the current detecting unit 14. The onboard control apparatus 420 specifies the potential difference across the resistor portion 11A based on a detection value of the voltage detecting unit 15. The onboard control apparatus 420 specifies the temperature of the heating object 11 based on a detection value of the temperature detecting unit 16. The onboard control apparatus 420 includes a duty ratio control unit 421, a current control unit 422, and a switching unit 423.

The duty ratio control unit 421 is configured similarly to the duty ratio control unit 21 of the first embodiment.

The current control unit 422 performs the current control so as to change the current supplied to the resistor portion 11A while continuously supplying the current to the resistor portion 11A. In the current control, the current to be supplied to the resistor portion 11A is smaller than a largest current that flows through the resistor portion 11A in the duty ratio control. The current control unit 422 is constituted by an MCU and a DA converter, for example.

When a switching condition is established while the duty ratio control unit 421 is performing the duty ratio control, the switching unit 423 switches to the current control by the current control unit 422. The switching condition is that the current detected by the current detecting unit 14 exceeds a threshold current, for example. The switching unit 423 may be constituted by an MCU, for example.

The following description relates to the details of the duty ratio control unit 421, current control unit 422, and switching unit 423.

When the start condition described in the first embodiment is established, the switching unit 423 causes the duty ratio control unit 421 to start the duty ratio control. Note that, here, the current control by the current control unit 422 is not performed. That is, the third switch 419 is off.

The duty ratio control unit 421 performs the duty ratio control similarly to the duty ratio control unit 21 of the first embodiment when the aforementioned start condition is established. A first signal output from the duty ratio control unit 421 is directly input to the input portion 13A of the switch 13 rather than via the switching unit 423. Accordingly, the switch 13 is subjected to the duty ratio control performed by the duty ratio control unit 421, and a rectangular wave current is supplied to the resistor portion 11A.

When the aforementioned switching condition is established while the duty ratio control unit 421 is performing the duty ratio control, the switching unit 423 causes the duty ratio control unit 421 to stop the duty ratio control, and causes the current control unit 422 to perform current control.

Upon receiving a stop instruction from the switching unit 423 as a result of the aforementioned switching condition being established, the duty ratio control unit 421 outputs an off signal to the input portion 13A of the switch 13. When the off signal is input to the input portion 13A, the switch 13 is turned off, and power supply to the resistor portion 11A via the switch 13 stops.

When the aforementioned switching condition is established, the current control unit 422 starts the current control. In the current control, the current control unit 422 changes the current to be supplied to the resistor portion 11A by changing the voltage applied to the third input portion 419A. The current control unit 422 changes the voltage applied to the third input portion 419A in a voltage range that is greater than or equal to the third threshold voltage. For example, the current control unit 422 adjusts the voltage applied to the third input portion 419A in a voltage range that is greater than or equal to the third threshold voltage and less than or equal to the voltage of an on signal input to the input portion 13A of the switch 13 from the duty ratio control unit 421. Note that the voltage of the on signal input to the input portion 13A of the switch 13 from the duty ratio control unit 421 is larger than the threshold voltage. The current control unit 422 performs the current control such that the power supplied to the resistor portion 11A approaches the target power similarly to the current control unit 22 of the first embodiment. A second signal generated by the current control unit 422 is directly input to the third input portion 419A of the third switch 419 rather than via the switching unit 423. Accordingly, a current according to the voltage of the second signal is supplied to the resistor portion 11A.

As described above, the onboard control apparatus 420 of the fourth embodiment changes the current to be supplied to the resistor portion 11A by adjusting the voltage applied to the third input portion 419A of the third switch 419 provided in parallel to the switch 13. Therefore, in the onboard control apparatus 420, the switch 13 can be configured to be suitable for the duty ratio control, and the third switch 419 can be configured to be suitable for current control.

### Fifth Embodiment

The switching condition is not limited to the condition stated in the first embodiment. In a fifth embodiment, a different example of the switching condition will be described. The fifth embodiment will be described below with reference to FIG. 1.

The switching condition of the fifth embodiment is that the temperature detected by the temperature detecting unit 16 has exceeded a threshold temperature. The threshold temperature is higher than the duty ratio switching temperature.

The onboard control apparatus 20 of the fifth embodiment may aim to smoothly increase the temperature of the heating object 11 by the duty ratio control until the temperature of the heating object 11 exceeds a threshold temperature, and suppress radiation noise from becoming too large after the temperature of the heating object 11 has exceeded the threshold temperature.

### Sixth Embodiment

In a sixth embodiment, a second different example of the switching condition will be described. In the description of the sixth embodiment below, constituent elements that are the same as those of the first embodiment are given the same reference numerals, and a detailed description thereof will be omitted.

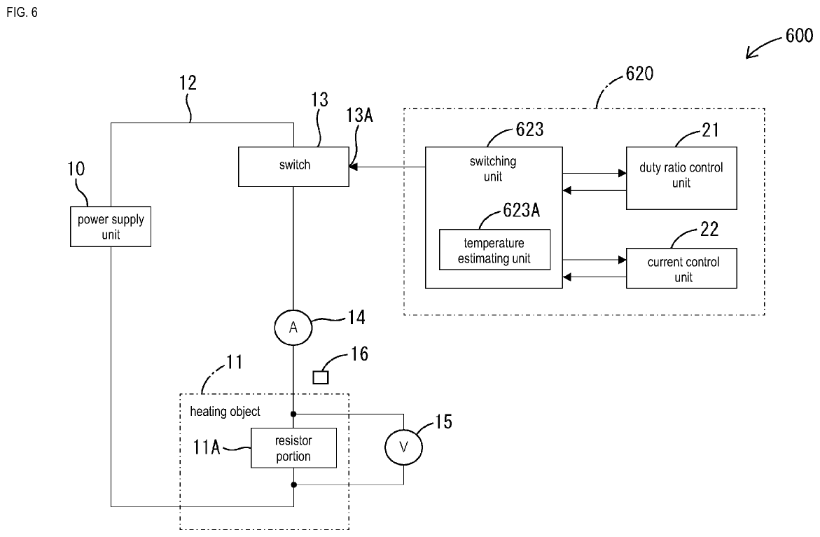

An onboard system 600 shown in FIG. 6 includes the power supply unit 10, the heating object 11, the power path 12, the switch 13, the current detecting unit 14, the voltage detecting unit 15, the temperature detecting unit 16, and an onboard control apparatus 620.

The onboard control apparatus 620 is an apparatus to be used in the onboard system 600. The onboard control apparatus 620 includes an MCU (Micro Controller Unit), an AD converter, a DA converter, a driving circuit, and a multiplexer, which are not illustrated. The onboard control apparatus 620 specifies the current flowing through the resistor portion 11A based on a detection value of the current detecting unit 14. The onboard control apparatus 620 specifies the potential difference across the resistor portion 11A based on a detection value of the voltage detecting unit 15. The onboard control apparatus 620 specifies the temperature of the heating object 11 based on a detection value of the temperature detecting unit 16. The onboard control apparatus 620 includes the duty ratio control unit 21, the current control unit 22, and a switching unit 623.

When a switching condition is established while the duty ratio control unit 21 is performing the duty ratio control, the switching unit 623 switches to the current control by the current control unit 22. The switching unit 623 includes a temperature estimating unit 623A. The temperature estimating unit 623A estimates the temperature of the resistor portion 11A based on a current detected by the current detecting unit 14, a voltage detected by the voltage detecting unit 15, and relational data indicating the relationship between the resistance and temperature of the resistor portion 11A. The relational data may be represented by a computation formula, or may also be table data. The temperature estimating unit 623A specifies the resistance of the resistor portion 11A based on a current detected by the current detecting unit 14 and a voltage detected by the voltage detecting unit 15. Also, the temperature estimating unit 623A specifies the temperature corresponding to the specified resistance based on the relational data stored in advance. The temperature specified in this way is the estimated temperature. The switching condition is that the temperature estimated by the temperature estimating unit 623A has exceeded a threshold temperature.

The onboard control apparatus 620 of the sixth embodiment may aim to smoothly increase the temperature of the heating object 11 by the duty ratio control until the estimated temperature of the heating object 11 exceeds a threshold temperature, and suppress the radiation noise from becoming too large after the estimated temperature of the heating object 11 has exceeded the threshold temperature.

### Seventh Embodiment

In a seventh embodiment, a third different example of the switching condition will be described. In the description of the seventh embodiment below, constituent elements that are the same as those of the first embodiment are given the same reference numerals, and a detailed description thereof will be omitted.

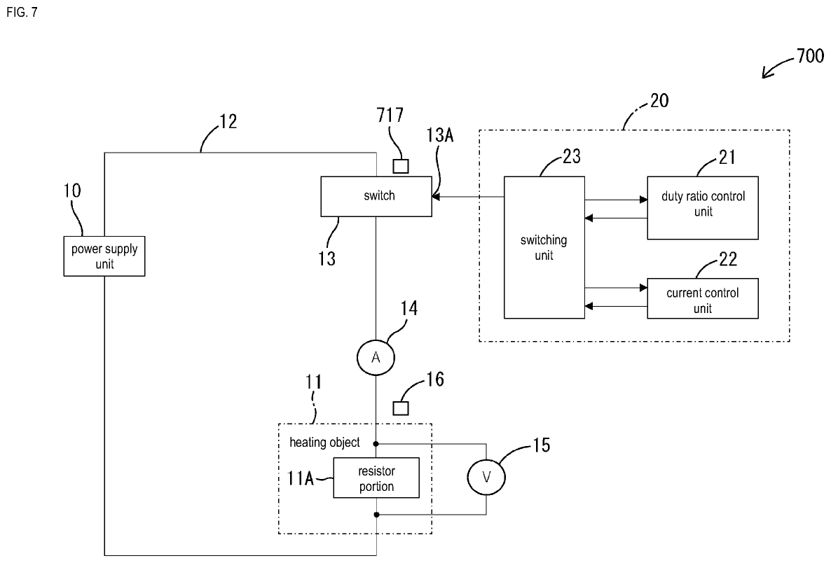

An onboard system 700 shown in FIG. 7 includes the power supply unit 10, the heating object 11, the power path 12, the switch 13, the current detecting unit 14, the voltage detecting unit 15, the temperature detecting unit 16, a second temperature detecting unit 717, and the onboard control apparatus 20.

The second temperature detecting unit 717 detects the temperature of the switch 13. The second temperature detecting unit 717 is configured as a known temperature sensor, for example. The switching condition is that the temperature detected by the second temperature detecting unit 717 has exceeded a second threshold temperature.

The onboard control apparatus 20 of the seventh embodiment can reduce the current to be supplied to the resistor portion 11A when the temperature of the switch 13 has exceeded the second threshold temperature. Therefore, the onboard control apparatus 20 of the seventh embodiment can suppress failure of the switch 13 due to heat generation.

### OTHER EMBODIMENTS

The present disclosure is not limited to the embodiments illustrated by the above description and drawings. For example, the features of the embodiments described above and below can be combined as long as no contradiction arises. Also, any feature of the embodiments described above and below may be omitted provided they are not explicitly indicated as being essential. Furthermore, the embodiments described above may be modified as follows.

In the embodiments described above, the duty ratio control unit is configured to perform the first duty ratio control and the second duty ratio control, in the duty ratio control, but the configuration is not limited to this. For example, the duty ratio control unit may also be configured to perform only the second duty ratio control in the duty ratio control.

In the embodiments described above, the duty ratio control unit is configured to perform the duty ratio control such that the power to be supplied to the resistor portion approaches a target power, but may also perform the duty ratio control such that the temperature of the heating object approaches a target temperature.

In the embodiments described above, when a switching condition is established, the current control unit is configured to perform the current control such that the power to be supplied to the resistor portion approaches a target power, but may also be configured to perform the current control such that the temperature of the heating object approaches a target temperature.

The duty ratio control unit, current control unit, and switching unit may be constituted by a single MCU, or may also be constituted by separate MCUs.

It should be noted that the embodiments disclosed herein should be considered as examples in all respects and not restrictive. The scope of the present disclosure is not limited to the embodiments disclosed herein, and is intended to include all modifications within the scope indicated by the claims or within a scope equivalent to the claims.

1. An onboard control apparatus that is used in an onboard system including a power supply unit, a heating object including a resistor portion whose resistance decreases as the temperature increases, a power path for supplying power based on the power supply unit to the resistor portion, and a switch provided on the power path, and controls power supply to the heating object, the onboard control apparatus comprising:
a duty ratio control unit configured to perform duty ratio control so as to turn the switch on and off at a set duty ratio;
a current control unit configured to perform current control so as to change a current to be supplied to the resistor portion while continuously supplying the current to the resistor portion; and
a switching unit configured to switch, when a switching condition is established while the duty ratio control unit is performing the duty ratio control, to the current control by the current control unit.

2. The onboard control apparatus according to claim 1,
wherein the duty ratio control unit performs the duty ratio control such that the power to be supplied to the resistor portion approaches a target power or the temperature of the heating object approaches a target temperature, and
the current control unit performs, when the switching condition is established, the current control such that the power to be supplied to the resistor portion approaches the target power or the temperature of the heating object approaches the target temperature.

3. The onboard control apparatus according to claim 1,
wherein the switch includes an input portion, is turned on when a voltage greater than or equal to a threshold voltage is applied to the input portion, and is turned off when a voltage less than the threshold voltage is applied to the input portion or a voltage is not applied to the input portion, and
the current control unit changes, in the current control, the current to be supplied to the resistor portion by adjusting the voltage applied to the input portion.

4. The onboard control apparatus according to claim 1,
wherein the onboard system includes:
a parallel conduction path provided in parallel to the switch between the power supply unit and the resistor portion; and
a DC-DC converter provided on the parallel conduction path, and
the current control unit changes, in the current control, the current to be supplied to the resistor portion by controlling the DC-DC converter while continuously supplying the current to the resistor portion.

5. The onboard control apparatus according to claim 1,
wherein the onboard system includes:
a parallel conduction path provided in parallel to the switch between the power supply unit and the resistor portion;
a suppressing circuit that is provided on the parallel conduction path and whose resistance increases as the temperature increases; and
a second switch that is provided on the parallel conduction path and is connected in series to the suppressing circuit, and
the current control unit turns on the second switch in the current control.

6. The onboard control apparatus according to claim 1,
wherein the onboard system includes:
a parallel conduction path provided in parallel to the switch between the power supply unit and the resistor portion; and
a third switch provided on the parallel conduction path,
the third switch includes a third input portion, is turned on when a voltage greater than or equal to a third threshold voltage is applied to the third input portion, and is turned off when a voltage less than the third threshold voltage is applied to the third input portion or a voltage is not applied to the third input portion, and
the current control unit changes, in the current control, the current to be supplied to the resistor portion by adjusting the voltage applied to the third input portion.

7. The onboard control apparatus according to claim 1,
wherein the onboard system includes a current detecting unit configured to detect a current flowing through the resistor portion, and
the switching condition is that the current detected by the current detecting unit has exceeded a threshold current.

8. The onboard control apparatus according to claim 1,
wherein the onboard system includes a temperature detecting unit configured to detect a temperature of the heating object, and
the switching condition is that the temperature detected by the temperature detecting unit has exceeded a threshold temperature.

9. The onboard control apparatus according to claim 1,
wherein the onboard system includes a current detecting unit configured to detect a current flowing through the resistor portion, and a voltage detecting unit configured to detect a potential difference across the resistor portion,
the onboard control apparatus further comprises
a temperature estimating unit configured to estimate the temperature of the resistor portion based on the current detected by the current detecting unit, the voltage detected by the voltage detecting unit, and relational data indicating the relationship between the resistance and the temperature of the resistor portion, and
the switching condition is that the temperature estimated by the temperature estimating unit has exceeded a threshold temperature.

10. The onboard control apparatus according to claim 1,
wherein the onboard system includes a second temperature detecting unit configured to detect a temperature of the switch,
the switching condition is that the temperature detected by the second temperature detecting unit has exceeded a second threshold temperature, and
the current control unit performs the current control so as to supply a current smaller than a largest current in the duty ratio control to the resistor portion.
